(19) United States
(12) Patent Application Publication
(10) Pub. No.: US 2009/0094920 A1
(43) Pub. Date: Apr. 16, 2009

(54) Fibrous insulation building products having reduced gaseous emissions

(76) Inventors: Charles R. Weir, Westerville, OH (US); Fatemeh N. Olang, Granville, OH (US); Harry B. Cline, Heath, OH (US); Anthony L. Maurer, Alexandria, OH (US); Mohammed Tazi, New Albany, OH (US)

Correspondence Address: OWENS CORNING, 2790 COLUMBUS ROAD, GRANVILLE, OH, 43023, US

(21) Appl. No.: 11/974,264

(22) Filed: Oct. 12, 2007

(51) Int. Cl. B32B 27/12; B32B 7/04; B32B 27/04; B65D 85/00

(52) U.S. Cl. 52/404.1; 156/72; 206/7; 442/121; 442/218

(57) ABSTRACT

A fibrous glass insulation building product includes a fibrous glass body of fibrous materials having at least one binder material that emits gaseous materials, and a gas absorbent material.

### TECHNICAL FIELD AND INDUSTRIAL APPLICABILITY OF THE INVENTION

Fibrous glass insulation building products have gaseous absorbent materials such that emissions from fibrous glass building products are reduced.

### BACKGROUND OF THE INVENTION

Glass and other organic and inorganic fibers come in various forms and can be used for a variety of applications. During the preparation and use of glass fiber products, whether produced by centrifuging or continuous filament manufacturing processes, the included glass fibers are easily weakened by the self-abrasive effect caused by the relative motion of adjacent fibers at points of contact. This self-abrasive effect produces surface defects in the glass fiber filaments, and these defects tend to reduce the overall mechanical strength of the product.

The glass fibers are typically bonded together to form an integral batt or layer structure by applying a binder material to the fibers. The collection of binder-coated fibers is then cured, typically in a curing oven, to evaporate remaining solvent and set the binder material. The fibers in the resulting fiber product thus remain partially coated with a thin layer of the binder material and may exhibit greater accumulation or agglomeration of the binder material at junctions formed where adjacent fibers are in contact or the spacing between them is very small. As a result of the improved strength and resiliency, the resulting fiber products exhibit higher recovery and stiffness than fiber products that do not incorporate a binder material.

During the manufacturing, the residual heat from the glass fibers and the flow of air through the fibrous batt or layer structure during the forming operations are generally sufficient to volatilize a majority of the water from the binder material, thereby leaving the remaining components of the binder material on the fibers as a viscous or semi-viscous high-solids liquid. The coated fibrous batt or layer structure is then transferred out of the forming chamber to a transfer zone.

There is a need for an improved system for making fibrous insulation building products that allows for the continued use of desired binder formulations, while reducing emission of gases into the environment.

There is also a need to reduce the volatility of any residual gases that may be emitted from the insulation products.

The invention will be more readily understood from the following description of a preferred embodiment thereof given, by way of example, with reference to the accompanying drawings.

### SUMMARY OF THE INVENTION

Fibrous glass insulation building products include a fibrous glass body comprising fibrous materials having at least one binder material that emits gaseous materials, and a gas absorbent material. In certain embodiments, the gas absorbent material comprises granules present within interstices between fibrous materials and the binder material. In other embodiments, the absorbent material comprises a woven or nonwoven mat.

A package of fibrous glass building product includes a removable packaging material, a fibrous glass body of fibrous materials and at least one binder material that emits gaseous materials, and a gas absorbent material. In certain embodiments, the absorbent material is removable from the package, and in certain embodiments, is recyclable.

In certain embodiments, the building product is an insulation panel having at least one layer of the fibrous glass body where the gas absorbent material is at least near or adjacent to a major surface of the fibrous glass body. In other embodiments, the insulation panel includes granules of the gas absorbent material within the fibrous glass body itself.

The fibrous glass building product can be made by providing a fibrous glass body of fibrous material and binder material that emits at least one gaseous material. A gas absorbent material is placed at least near or adjacent to the fibrous glass body. In certain embodiments, heat is applied to the fibrous glass body so that the absorbent material absorbs a quantity of the gases emitted by the fibrous glass body.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a plan view of a fibrous glass insulation building product that is made of a fibrous glass body of fibrous materials having at least one binder material that emits gaseous materials, and a gas absorbent material.

FIG. 2 is a cross-sectional view of two fibrous glass insulation building products.

FIG. 3 is a cross-sectional view of a package containing two fibrous glass insulation building.

FIG. 4 is a cross-sectional view of a part of a fibrous glass insulation building product that is made of a fibrous glass body of fibrous materials having at least one binder material that emits gaseous materials, a gas absorbent material, and a facing material.

### DETAILED DESCRIPTION AND PREFERRED EMBODIMENTS OF THE INVENTION

Glass fiber and glass wool fibrous insulation building products are generally formed by fiberizing molten material. Typically, the fibers for insulation products are mineral fibers, such as glass fibers, although some insulation products are made of organic fibers, such as polypropylene and polyester.

The fibers are formed into individual insulation materials and the insulation materials are packaged for shipping to customer locations. These insulation building products include, for example, blankets, mats, batts, multi-layered panels, and resin-reinforced insulation boards.

Most fibrous insulation building products contain a binder material to bond the fibers together where they contact each other, forming a lattice or network. The binder gives the fibrous insulation building products resiliency for recovery after packaging, and provides stiffness and handleability so that the building products can be handled and used as needed.

Binder materials are typically organic resin materials. The organic resin materials exist in the uncured state as liquids in solution. Thus, they can be easily applied to fibrous materials by spraying or other well-known means. Resin materials can be cured to crosslink the resin and provide strong bonds with the fibrous material. These advantages allow cost effective manufacture of fibrous insulation building products. The binder materials generally emit gaseous materials, (for example, volatile organic compounds (VOCs)) that are slowly diffused from, or given off, over time. It is a continuing desire for the building industry to improve indoor air quality. Also, while the rate of emissions lessens over time, the initial period after installation of the fibrous insulation building products has the greatest rate of gaseous emissions. This initial emission rate is especially noticeable when the fibrous insulation building products are enclosed in relatively air-tight packaging for storage and shipping. Over time, during the storage and shipping of the building products, the gaseous emissions build-up within the package. Therefore, when the package is finally opened for installation, the gaseous emissions can be most noticeable, at the least, annoying.

Also, in various end use applications and during transport and storage of these materials, the fibrous insulation building products are exposed to high temperatures and humidity that, over time, can degrade or breakdown the binder materials causing further emission of gases.

The release of emissions is of particular interest for fibrous glass insulation materials when phenol-formaldehyde binder formulations are used in the manufacture of the glass fiber and glass wool insulation materials. These binder formulations have a low viscosity in their uncured state, yet form a rigid thermoset polymeric matrix for the glass fibers when cured.

Typically, for fiber products incorporating phenolic binders the curing ovens are operated at a temperature from about 200° C. to about 325° C. and preferably from about 250° C. to about 300° C. with curing processes taking between about 30 seconds and 3 minutes. Phenol-formaldehyde binder materials are generally characterized by relatively low viscosity when uncured and the formation of a rigid thermoset polymeric matrix with the fibers when cured. A low uncured viscosity simplifies binder application and allows the binder-coated fiber product to expand more easily when the forming chamber compression is removed. Similarly, the rigid matrix formed by curing the binder material allows a finished fiber product to be compressed for packaging and shipping and then recover to substantially its full original dimension when unpacked for installation. Phenol/formaldehyde binders utilized in some applications have been highly alkaline resole (also referred to as resole or A-stage) type that are relatively inexpensive and are water soluble. These binders are typically applied to the fibers as an aqueous solution shortly after the fibers are formed and then cured at elevated temperatures. The curing conditions are selected both to evaporate any remaining solvent and cure the binder to a thermoset state. The fibers in the resulting product tend to be partially coated with a thin layer of the thermoset resin and exhibit accumulations of the binder composition at points where fibers touch or are positioned closely adjacent to each other.

The phenol-formaldehyde resole binders used in manufactured boards and fiber insulation products often release formaldehyde during the curing process. One technique that has been used to reduce formaldehyde emission from the phenol/formaldehyde resins during curing is the use of various formaldehyde scavengers that may be added to the resin during or after its preparation. Urea is a commonly used formaldehyde scavenger that is effective both during and subsequent to the manufacture of the fiber product. Urea is typically added directly to the phenol/formaldehyde resin, to produce a urea-extended phenol/formaldehyde resole resin (also referred to as “premix” or “pre-react”). Further, urea, being less expensive than the alkaline phenol/formaldehyde resoles commonly used as binders, can provide substantial cost savings for fiber product manufacturers while simultaneously reducing formaldehyde emissions. The urea is still present and often contributes to the gaseous emissions from the fibrous glass products.

Alternative polymeric binder systems for fibrous glass products having low molecular weight, low viscosity binders designed to allow for maximum vertical expansion of the batt as it exits the forming stage also tend to form a non-rigid plastic matrix when cured, thus reducing the vertical height recovery properties of the final product after compression. Conversely, higher viscosity binders that tend to cure to form a rigid matrix interfere with the vertical expansion of the coated, but uncured, fiber batt as it exits the forming stage. These problems were addressed with a variety of non-phenol/formaldehyde binders exhibiting low uncured viscosity and structural rigidity when cured. These binders are often referred to as formaldehyde-free. While it is accurate that the binder is free of formaldehyde when mixed, the cured fiberglass product does include measurable amounts of formaldehyde. Therefore, traditional phenol/formaldehyde resole binders continue to be very attractive as a result of their significantly lower cost.

For environmental reasons, and in order to lower the amount of phenol used in the manufacture of these phenolic binders, a much higher ratio of formaldehyde to phenol has been used in the preparation of the resole part of the phenol-formaldehyde binder. More recently, the phenol-formaldehyde resole binders have been modified using urea. Urea is added to the phenol-formaldehyde resole to react with the free formaldehyde. Upon completion of this reaction, the urea modified phenol-formaldehyde binder level is well below 1% of the amount of formaldehyde used. However, due to the amount of binder materials used in the manufacture of insulation products, the release of the free formaldehyde into the environment is still undesirable. Further, it has been found that the modification of these phenol-formaldehyde resole resins with urea reduces the stability of the resin.

As such, the manufacture, storage and transportation of fibrous insulation materials present opportunities for the emission of gaseous emissions into the atmosphere, as well as the accumulation of highly explosive vapors in storage facilities and processing equipment.

In view of the gaseous emissions present, methods to control their accumulation and escape have been developed. In one such method, the gaseous emissions are drawn into a flame incinerator where they are combusted. Unfortunately, the incineration of such emissions by a flame burner is expensive, and the temperatures reached in such incinerators often favor the formation of nitrous oxides.

Fiberglass insulation building products prepared in this manner can be provided in various forms including mats, panels, batts, boards (a heated and compressed batt) and molding media (an alternative form of heated and compressed batt) for use in different applications.

The glass fibers incorporated in building product products typically have diameters from about 2 to about 9 microns and may range in length from about 0.25 inch (0.64 cm) to the extremely long fibers used in forming “continuous” filament products. Other lengths and diameters can also be used.

Most fiberglass board building products will have a density of between 1 and 10 lbs/ft³ (16 and 160 kg/m³) with about 7 to about 12 wt % binder while fiberglass molding media will more typically have a density between 10 and 20 lbs/ft³ (160 and 320 kg/m³) with at least about 12 wt % binder.

Most fiberglass batt insulation building products will have a density of less than 1 lb/ft³ (16 kg/m³) with about 4.5 wt % being binder. These batts can be packaged in various ways. The batts can be staggered and rolled together along their lengths so that a roll would contain about 10 batts.

For example, during the manufacture of batts, as the batt of binder-coated fibers emerges from the forming chamber, the batt will tend to expand as a result of the resiliency of the glass fibers. The expanded batt is then typically conveyed to and through a curing oven in which heated air is passed through the insulation product to cure the binder. In addition to curing the binder, within the curing oven the insulation product may be compressed with flights or rollers to produce the desired dimensions and surface finish on the resulting blanket, batt or board product. Furthermore, glass fiber products, particularly those products destined for use as building insulation and sound attenuation, are often wrapped in a packaging material and shipped in a compressed form in order to lower shipping costs.

In the manufacturing of molding media, after partially curing the binder, the fiber product is fed into a molding press that will be used to produce the final product shape and to complete the curing process.

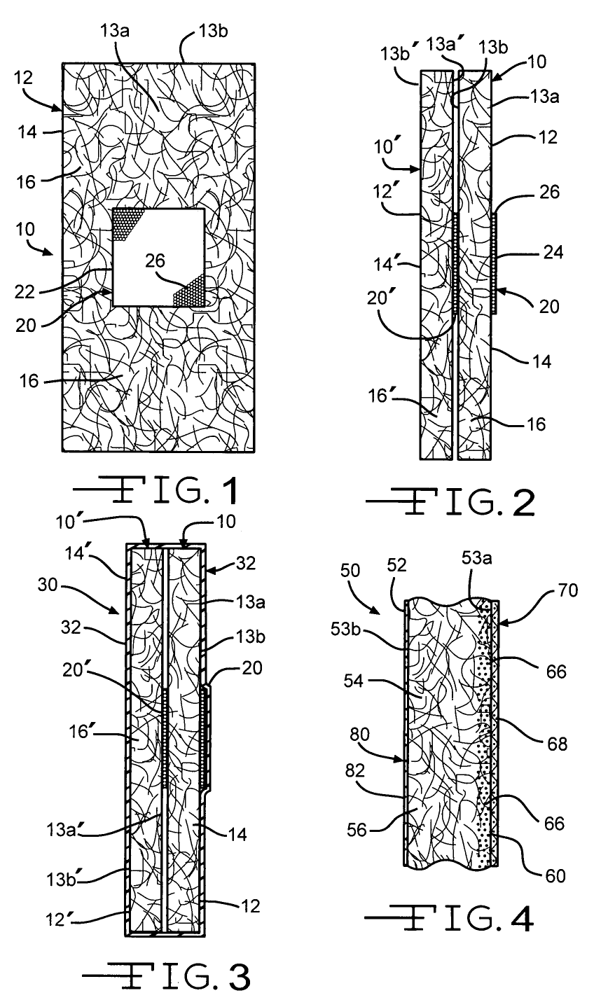

Referring now to the drawings, FIG. 1 illustrates a fibrous glass insulation building product 10 which includes a fibrous glass body 12 having an upper surface 13a and, as best seen in FIG. 2, a lower surface 13b. The fibrous glass body 12 includes a plurality of fibrous materials 14 having a coating of at least one binder material 16. When the fibrous glass insulation building product 10 is first formed, it may sometimes emit gaseous materials, where some of the gaseous materials may have undesirable odors.

As described herein, the fibrous glass insulation building product 10 includes at least one gas absorbent material 20. In the embodiments shown in FIGS. 1, 2 and 3, the absorbent material 20 comprises a woven or nonwoven permeable mat 22 such as, for example, a sheet, film or textile material. The mat 22 can have an open weave or permeable configuration that allows for the flow of gases through the mat 22. In certain embodiments, the mat 22 can be comprised of fibers which themselves are made of gas absorbing materials such as, for example, activated carbon fibers. In other embodiments, the mat 22 can be made of an open or permeable material that is coated with, or has entrained therein, gas absorbing materials such as, for example, granules 26 of activated charcoal. In certain embodiments, the absorbent material comprises between about 0.05 to about 1.0%, by weight, of the fibrous glass body 12.

In certain embodiments, the gas absorbent material 20 is adjacent or near a major surface 13a and/or 13b of the fibrous glass body 12. In other embodiments, the gas absorbent material 20 is touching at least a portion of a major surface 13a and/or 13b of the fibrous glass body 12. In still other embodiments, the gas absorbent material 20 is within the fibrous glass body 12 itself.

Also, in certain embodiments, the absorbent materials 20 are readily removable without damaging the fibrous glass body, and in certain embodiments, the absorbent materials 20, 20′ are recyclable. In other embodiments the materials are adsorbent materials. Various absorbent materials 20 can be reused, by for example, heating or exposing to sunlight.

FIG. 2 shows two fibrous glass insulation building products 10 and 10′ that are arranged in a stacking manner. Each fibrous glass insulation building product 10, 10′ includes the fibrous glass body 12, 12′ and at least one gas absorbent material 20, 20′, respectively.

In certain embodiments, as schematically illustrated in FIG. 2, the absorbent material 20 includes a permeable bag 24 having granule or particulate material 26 within the permeable bag 24.

FIG. 3 shows a package 30 of fibrous glass building products 10, 10′ stacked within a removable packaging material 32. The packaging material 32 can be a thin plastic material or bag or a shrink-wrap material. As the gases within the fibrous glass bodies 12, 12′ diffuse from the fibrous glass bodies 12, 12′ over time, the gases are at least temporarily trapped within the packaging material 32. In the embodiment illustrated in FIG. 3, the absorbent materials 20, 20′ then absorb the gases so that when the packaging material 32 is removed, there is little or no odor. In certain embodiments, the absorbent materials 20, 20′ are removable from the package, and in certain embodiments, the absorbent materials 20, 20′ are recyclable.

In certain embodiments, the building product 10 is an insulation panel where the gas absorbent material is adjacent to a major surface 13a, 13b of the fibrous glass body 12. For ease of illustration herein the building product 10 is generally shown as a panel, however, it is to be understood that the building products can include, without being limited to such building products as, for example, blankets, mats, batts, multi-layered panels, and resin-reinforced insulation boards. As shown in FIGS. 1 and 3, the absorbent amterial 20 need not be coextensive with the length or width of the panels, but may instead be sized and positioned as deemed adequate to absorb an adequate amount of the gas emitted.

The embodiment shown in FIG. 4 illustrates a fibrous glass insulation panel 50 that includes a fibrous body 52 having an upper surface 53a and a lower surface 53b. The fibrous body 52 includes a plurality of individual fibrous materials 54 having a coating of at least one binder material 56. When the fibrous glass insulation building product 10 is first formed, it may sometimes emit gaseous materials, where some of the gaseous materials may have undesirable odors.

In the embodiment shown in FIG. 4, the fibrous glass insulation building panel 50 includes at least one gas absorbent material 60. The absorbent material 60 comprises a plurality of granules 66 which are present within interstices 68 between the individual binder-coated fibrous materials 54. The absorbent material granules 66 can be applied so that the granules 66 adhere to the binder material 56 coating the surfaces of the individual fibrous materials 54. In certain embodiments, the granules 66 are dispersed in the fibrous glass body 52 rather than as a “dusting” on the surface 53a. Also, in certain embodiments, the granules 66 are dispersed in the fibrous glass body 52 in a penetrating gradient where there is a higher concentration of the granules 66 at, or near, the top surface 53a of the fibrous glass body 53. The concentration of granules 66 progressively decreases from the top surface 53a towards the bottom surface 53b.

In the embodiment shown in FIG. 4, the fibrous glass insulation building panel 50 includes an optional layer 70 on the upper surface 53a, but preferably not so large as to effect a protrusion which is read through the layer 70. The layer 70 is generally depicted in FIG. 4 as a fabric material, such as could be used in a basement finishing system; however, in other embodiments, the layer 70 could also be a facing material which acts as a moisture barrier, reflective surface, protective film or the like. The granules 66 can be dispensed into the fibrous body 52 before the layer 70 is placed on the fibrous glass body 53. In certain embodiments, the penetrating gradient of granules 66 within the fibrous glass body 53 provides the top surface 53a with a desired quantity of “granule-free” binder-coated fibrous materials 54. The “granule-free” areas of the top surface 53a provide an adequate surface area so that the layer 70 can be directly adhered to the binder-coated fibrous materials 54 on the top surface 53a.

Also, in the embodiment shown in FIG. 4, the fibrous glass insulation building panel 50 includes a backing layer 80 on the lower surface 53b. The backing layer can include granules 82 of absorbent materials.

In certain embodiments, when the granules 66 are applied to the upper surface 53a, the granules 66 fall into the interstices 58 so that when the layer 70 is applied to the upper surface 53a, the granules 66 do not interfere with the adhesion of the layer 70 to the upper surface 53a of the fibrous glass body 12. In such embodiments, it is desired that the granules 66 have a large enough average diameter, such as, for example, a #40 mesh granule material, so that the granules 66 do not act as a powder or dust on the upper surface 53a, and thus do not cause the layer 70 to be adhered to any powdered surface, rather than to the upper surface 53a.

In another aspect, a method for forming the fibrous glass fibrous 12 includes placing a gas absorbent material 20 near or on the fibrous glass body 12 before the fibrous glass body is subjected to a heating and/or curing step. As heat is applied to the fibrous glass body, the absorbent material absorbs a quantity of the gases emitted by the fibrous glass body.

In certain other methods, the absorbent material 20 can be placed between the upper surface 53a of the fibrous glass body 52 and the layer 70 prior to applying the heat. In other methods, the absorbent material is placed in a permeable bag. The permeable bag can remain with the building product, or can be removed from adjacent the fibrous glass body after the heating step.

In other methods, the absorbent material 60 can be incorporated into the backing layer 80, and the backing layer is then applied to a major surface of the fibrous glass body.

### EXAMPLES

Different types of gas absorbent materials were evaluated to determine whether formaldehyde and trimethylamine (TMA) emissions were reduced in Owens Corning basement finishing system glass fiber panels. The samples were prepared and placed in a humidity chamber at 90° F. and 90% relative humidity for 2 days. The samples were then removed and evaluated over a period of days for any distinct odors. The following Table 1 shows the rank order of the gas odors as the days progressed, where a rank of 1 means the least amount of detectable odor. The permeable bags contained about 5 grams of activated charcoal. The fabric contained about 50%, by weight, activated charcoal and about 50%, by weight, spunbonded fibers (such as polyester, propylene, nylon, rayon and/or acrylic) with a total weight of about 0.9 oz/yd² (31 g/m²) and about 5#/ft³ density, such that 1 sq. yd has about 0.45 oz (about 15.5 g) activated charcoal.

TABLE 1

| | | | |
|---|---|---|---|
| | 2 days | 3 days | 13 days |
| Sample | post | post | post |

Permeable Bag

| | | | |
|---|---|---|---|
| 1 sleeve with 4 bags one in each corner, | 2 | 6 | 6 |
| total 20 g | | | |
| 1 sleeve with 6 bags, total 60 g | 5 | 5 | 5 |
| 1 sleeve with 8 bags, total 40 g | 6 | 4 | 4 |
| Activated Charcoal Fabric | | | |
| 4 - 1 sq. yd sheets in a sleeve, total 62 g | 3 | 2 | 2 |
| 4 - 2 sq yd sheets in a sleeve, total 124 g | 4 | 2 | 3 |
| Activated Charcoal Granules | | | |
| 4 boards w/32 grams per board in a sleeve | 1 | 1 | 1 |

In another test, the percent of reduction of formaldehyde was evaluated for fabrics having different adhesive materials. In the Table 2 below, fabric #1 is considered as having formaldehyde. Fabric #2 is considered as being “formaldehyde free”; as such, it was not expected that the permeable bags would cause a further reduction in the emissions. Each of the adhesives, #A, B and C were different. The sprinkled granules comprised about 1 gram of granules distributed over the sample. The dimensions of the permeable bags were 12″×12″.

TABLE 2

| | | | Formaldehyde | % |
|---|---|---|---|---|
| Fabric | Adhesive | Absorbent | (ppm) | Reduction |
| #1 | #a | none | 0.3 | — |
| | | sprinkled | 0.18 | 40 |
| | | granules | | |
| | | permeable bags | 0.28 | 1 |
| #1 | #b | none | 0.23 | — |
| | | sprinkled | 0.13 | 43 |
| | | granules | | |
| | | permeable bags | 0.23 | 0 |
| #2 | #c | none | 0.20 | — |
| | | sprinkled | 0.14 | 30 |
| | | granules | | |
| | | permeable bags | 0.26 | — |

In another test, the use of granules was compared to absorbent material fabric. Table 3 below shows the results where #40 mesh granules and carbon activated fabric were used to reduce the amount of formaldehyde present.

TABLE 3

| | |
|---|---|
| #40 mesh granules of activated charcoal | 70% reduction in formaldehyde |
| Carbon activated fabric | 30% reduction in formaldehyde |

All of the compositions and methods disclosed and claimed herein can be made and executed without undue experimentation in light of the present disclosure. While the compositions and methods of this invention have been described in terms of the foregoing illustrative embodiments, it will be apparent to those skilled in the art that variations, changes, modifications, and alterations may be applied to the compositions and/or methods described herein, without departing from the true concept, spirit, and scope of the invention.

What is claimed is:

1. A fibrous glass insulation building product comprising a fibrous glass body of fibrous materials having at least one binder material that emits gaseous materials, and a gas absorbent material.

2. The building product of claim 1, wherein the absorbent material comprises granules present within interstices between individual binder-coated fibrous materials.

3. The building product of claim 1, wherein the absorbent material comprises a woven or nonwoven mat.

4. The building product of claim 1, wherein the absorbent material comprises activated charcoal.

5. The building product of claim 1, wherein the absorbent material comprises between about 0.05 to about 1.0%, by weight, of the fibrous glass body.

6. A package of fibrous glass building product comprising:
a removable packaging material,
a fibrous glass body of fibrous materials having at least one binder material that emits gaseous materials, and
a gas absorbent material.

7. The package of claim 6, wherein the absorbent material is readily removable without damaging the fibrous glass body.

8. The package of claim 7, wherein the absorbent material is recyclable.

9. The package of claim 7, comprising an insulation panel having at least one layer of the fibrous glass body wherein the gas absorbent material is at least adjacent to a major surface of the layer of the fibrous glass body.

10. The package of claim 9, wherein the absorbent material is a granule or particulate material present in interstices within the fibrous glass body.

11. The package of claim 9, wherein the absorbent material is a sheet, film or textile material.

12. The package of claim 6, wherein the absorbent material comprises activated charcoal.

13. The package of claim 6, wherein the absorbent material comprises between about 0.05 to about 1.0%, by weight, of the fibrous glass body.

14. A method for preparing a fibrous glass building product including the steps of:
providing a fibrous glass body of fibrous material having a binder material that emits at least one gaseous material,
placing a gas absorbent material at least adjacent to the fibrous glass body, and
applying heat to the fibrous glass body whereby the absorbent material absorbs a quantity of the gases emitted by the fibrous glass body.

15. The method of claim 14, wherein the absorbent material comprises a woven or non-woven mat having activated charcoal therein.

16. The method of claim 15, including placing the mat adjacent a major surface of the fibrous glass body, and placing a facing material on the major surface prior to applying the heat.

17. The method of claim 16, wherein the absorbent material is within a permeable bag.

18. The method of claim 17, including removing the permeable bag from adjacent the fibrous glass body after the heating step.

19. The method of claim 14, including incorporating the absorbent material into a backing layer and applying the backing layer to the fibrous glass body.

20. The method of claim 14, wherein the absorbent material comprises between about 0.05 to about 1.0%, by weight, of the fibrous glass body.
